(19) United States
(12) Patent Application Publication
(10) Pub. No.: US 2004/0077344 A1
(43) Pub. Date: Apr. 22, 2004

(54) Test equipment and aparatus for digital mobile radio systems

(76) Inventors: Valerio Bernasconi, Torino (IT); Danilo Bessone, Torino (IT); Flavio Buscaglia, Torino (IT); Michele Lupano, Torino (IT); Vito Ribaudo, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/470,782

(22) PCT Filed: Jan. 28, 2002
(86) PCT No.: PCT/EP02/00869

(30) Foreign Application Priority Data
Jan. 31, 2001 (IT) T001A000090

(51) Int. Cl. H04Q 7/20

(52) U.S. Cl. 455/423

(57) ABSTRACT

The present invention relates to a test plant (10) for digital mobile radio systems comprising one or more radio base stations (RBSs) (12), a corresponding base station controller (BSC) (11) and a testing apparatus (14) interposed between the RBSs (12) and the BSC (11). The test plant (10), and the testing apparatus (14) in particular, make it possible to check mobile radio system performance while allowing proprietary Operation & Maintenance messages to travel transparently between the RBSs (12) and The BSC (11), and generating, in the apparatus (14), radio protocol messages (Radio signaling Link messages) which in general constitute the portion of information on which testing is carried out and are organized in accordance with predetermined standards. Thanks to the technique described, the testing apparatus (14) can be used in proprietary configuration belonging to any vendor or mobile radio systems without having to be specialized on a case by case basis in order to manage Operation & Maintenance messages, as is the case with prior art systems.

### FIELD OF THE INVENTION

The present invention relates to a test plant and apparatus for digital mobile radio systems. More particularly, the present invention relates to a testing apparatus to be used in digital mobile radio system test plants for checking system performance under varying operating conditions.

### BACKGROUND OF THE INVENTION

Test plants for digital mobile radio systems are known in the prior art. Such test plants are generally configured so as to simulate the architecture of deployed mobile radio systems in the laboratory.

In accordance with the object of the present invention, reference is made in particular to test plants which make it possible to check information exchange performance between one or more radio base stations (RBSs) and a c rresp nding base station controller (BSC).

As is known, radio base stations are capable of exchanging information with mobile radio terminals or MSs (Mobile Stations) consisting, for example, of cellular telephones, and of transferring and exchanging this information with the BSC.

In turn, the BSC is capable of exchanging information consisting in general of telephone traffic and messages with the RBSs and of monitoring the exchange of this information with, for example, a fixed telephone network.

Information exchange between the RBSs and the BSC is accomplished by means of exchange protocols which depend on the type of digital mobile radio system. In the case of GSM (Global System for Mobile Communications) mobile radio systems, for example, this protocol is called the A-bis interface and consists of:

A]—A physical layer in accordance with PCM (Pulse Code Modulation) standard G.703 and consisting of PCM frames with 32 time-slots (which will also be referred to hereunder as TSs);

B]—A layer 2 in accordance with the LAPD standard; and

C]—A layer 3 consisting of the actual information and which in turn comprises:

C1—Radio protocol messages or RSL (Radio Signaling Link) messages, which in general constitute the portion of information on which testing is carried out, and are organized in accordance with predetermined standards; and

C2—Operation & Maintenance (O&M) messages which are specific for each RBS and BSC vendor and consequently consist of messages which are proprietary, or in other words comply with proprietary standards belonging to the vendor of said stations.

Naturally, in communication between radio base stations (RBSs) and base station controllers (BSCs), digital mobile radio systems other than GSM use interfaces that are different but similar to the structure described for GSM netw rks. For the sake of simplicity, reference will thus be made here only to the GSM network and the A-bis interface.

Test plants for GSM mobile radio systems have architectures that take the characteristics of the A-bis interface layer 3 into account and in general comprise one or more RBSs from a particular vendor and a BSC from the same vendor. A test apparatus or instrument is usually inserted on the A-bis interface between the stations to be tested; as is known, this apparatus is capable of being used in the following modes:

Monitor mode, in which information can travel transparently and information in transit can be viewed;

Load generator mode, in which appropriate traffic can be generated in order to check performance of the RBSs (which substitute for the BSC) and/or the BSC (which substitutes for the RBSS) under particular load conditions or in the event of errors.

Naturally, if a telephone operator's deployed network uses RBSs or BSCs from different vendors, this architecture will be repeated as many times as there are vendors.

A technical disadvantage of prior art systems, and in particular of the instruments to be interposed between the RBSs and the BSC, consists in the fact that these instruments are not capable of generating radio signaling link messages without also inserting proprietary O&M messages. Consequent they are intrusive, given that they completely substitute the radio base stations when operating in load generator mode for the BSC.

A further disadvantage of prior art systems consists in the fact that these instruments cannot dispense with generating the proprietary O&M messages for each vendor; and thus cannot be used indiscriminately to analyze architectures provided by different vendors. As a result, these instruments must comprise as many configurations as there are vendors in the test plant.

Yet another technical disadvantage lies in the fact that the instruments cannot be used if information about the structure of O&M messages is not available, and it is thus necessary t equip test plants with instrumentation which is specifically marketed by the vendors of the RBSs and BSCs involved.

In brief, then, the prior art does not provide test plant instruments which can be connected nonintrusively on the interface between RBSs and BSC in load generator mode, and which can be used indiscriminately for testing architectures from different vendors.

### DISCLOSURE OF THE INVENTION

The object of the present invention is the implementation of flexible test plant which do not require that test architectures be specialized for the vendor of the mobile radio system to be tested.

Another object of the present invention is the implementation of a nonintrusive instrument for testing mobile radio systems which can be used on the interface between radio base stations and base station controller without substituting itself for the RBSs.

More particularly, the object of the present invention is to implement an instrument for use in test plants for digital mobile radio systems that can be connected nonintrusively in the interface between radio base stations (RBSs) and base station controller (BSC) and can generate loads consisting of radio signaling link messages (RSL messages) without having to generate proprietary O&M messages.

This object is achieved by the test plant and apparatus for digital mobile radio systems as described in the independent claims. In particular, this object is achieved by the test apparatus in accordance with the present invention which is capable of recognizing, e.g., in the case of GSM networks, the A-bis interface layer 3, of intercepting only the RSL messages between RBSs and BSC, and of allowing O&M messages to travel transparently.

### BRIEF DESCRIPTION OF THE DRAWINGS

The above and other features of the present invention will be better understood from the following description of a preferred embodiment of the invention, which is intended purely by way of example and is not to be construed as limiting, taken in conjunction with the accompanying drawings, where:

FIG. 1 represents a schematic diagram of the test plant for digital radio mobile systems in accordance with the present invention;

FIG. 2 represents a block diagram of the apparatus in accordance with the invention; and

FIG. 3 represents indicative message flow in the apparatus as shown in FIG. 2.

### DESCRIPTION OF A PREFERRED EMBODIMENT OF THE INVENTION

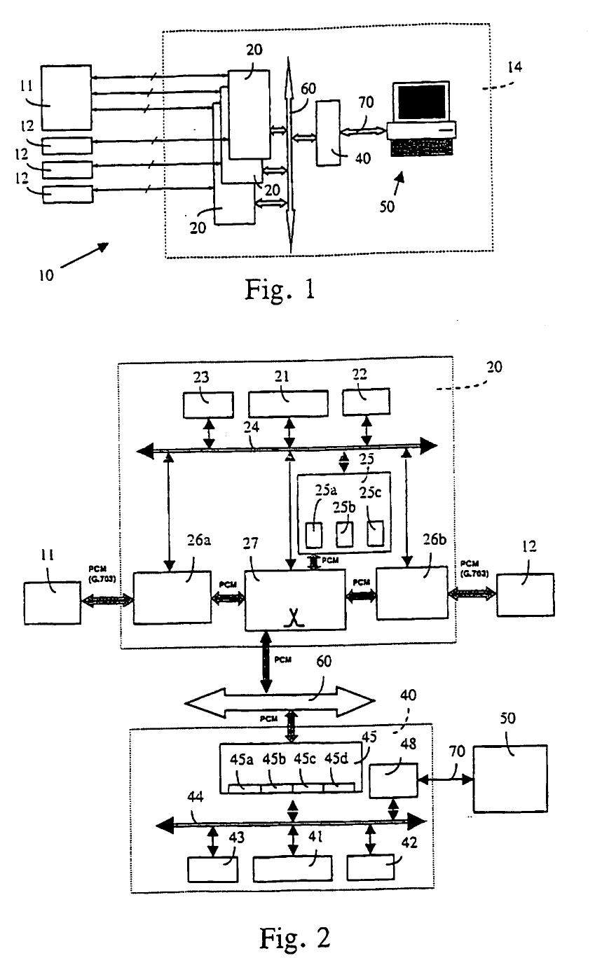

With reference to FIG. 1, a test plant for mobile radio systems 10 in accordance with the present invention comprises one or more radio base stations (RBSs) 12 of known type, a base station controller (BSC) 11, likewise of known type and capable of exchanging information consisting of telephone traffic and messages with the radio base stations 12 in accordance with a predetermined communication protocol, and a test apparatus (Instrument) 14 interposed between the base station controller 11 and the radio base stations 12 interfaced with the latter.

The BSC 11, for example an Ericsson BSC BYB202 for GSM mobile radio networks, is capable of exchanging information with the instrument 14 in compliance with the A-bis standard.

The RBSs 12, for example Ericsson RBS 2302 radio base stations, are configured so that they can exchange messages consisting of RSL (Radio Signaling Link) messages and O&M (Operation & Maintenance) messages with the instrument 14 in compliance with the A-bis standard.

The instrument 14 comprises one or more synchronization and switching devices (PCM drivers) 20 (FIG. 1 and FIG. 2), each interposed between an RBS 12 and the BSC 11, an RSL message generating device (RSL generator) 40 connected by means of an interconnection panel (interconnection bus) 60 to the PCM drivers 20, and an electronic computer 50 of known type, connected to the RSL generator 40 by means of a connection 70, e.g., a serial connection.

Each PCM driver 20, consisting for example of an electronic circuit board, comprises a CPU 21, e.g., an Intel 80C186X1ad 16-bit micropr cessor, a non-volatile memory (ROM) 23, e g., a 128 KB FLASH EPROM, and a volatile memory (RAM) 22, e.g., a 1 MB random access memory, all of known type and mutually interconnected in accordance with the prior art by means of an internal data and command channel (BUS) 24.

The ROM 23 is capable of storing variables and programs developed at the design stage for instrument 14, e.g., the boot program whereby the CPU 21 can perform a physical test on the board at the time the instrument is turned on. If this test is passed, the CPU 21 waits for commands of known type from computer 50 in order to load the executable program in RAM 22; said executable program may for example be resident in ROM 23 or in computer 50, and is capable of making the functions assigned to the PCM driver 20 operative as will be described in detail below.

In addition, the PCM driver 20 comprises two line interfaces (PCM interfaces) 26a and 26b of known type which consist, for example, of Dallas model DS2153Q interfaces, are connected to the BSC 11 and to the RBS 12 respectively, and are capable of managing 2 Mb/second PCM streams.

The PCM interfaces 26a and 26b are controlled by the CPU 21 via connections to the BUS 24 and are capable, in particular, of converting the PCM streams received from the BSC 11 and from the RBS 12 into TTL level logic signals and, in the opposite direction, of converting TTL signals into streams or line signals complying with G.703 specifications as required for connections conforming to the A-bis standard.

The PCM driver 20 also comprises a switch matrix 27 and a module of HDLC controllers (HDLC module) 25 (high speed data link controller) connected in accordance with the prior art to bus 24 and capable of being controlled by the CPU 21 as will be described in detail below.

The switch matrix 27 is also connected to the two PCM interfaces 26a and 26b by means f the respective TTL level PCM channels, to the HDLC module 25, and to the RSL generator 40 by means f the interconnection bus 60.

The switch matrix 27, which for example consists of an Infineon model PEB2055 peripheral, is capable of transferring the time-slots making up the PCM frames to an interface, e.g., the interface 26a, to the other interface 26b or to the other PCM channels and vice versa, depending on the control instructions established by the CPU 21 on the basis of the executable program stored in the RAM 22.

Through the switch matrix 27, it is thus possible to make the instrument 14 capable of retransmitting to the BSC 11 side whatever is received from the RBS 12 side and vice versa, as well as capable of filtering time-slots, e.g., those assigned to signaling. In particular, and on the basis of control instructions, switch matrix 27 is capable of being “transparent”, e.g., to those time-slots which do not carry significant information, of filtering the RSL and O&M messages received from one of the two PCM interfaces 26a or 26b, and of switching these messages, to the HDLC module 25 for example, by means of one of the PCM channels in the PCM driver 20.

The HDLC module 25 consists, for example, of three Infineon model SAB82532 HDLC peripherals designated respectively as 25a, 25b and 25c, each of which is provided in accordance with the prior art with two HDLCs (High speed Data Link Controllers).

Each HDLC controller can manage a signaling TS in compliance with the LAPD protocol. Consequently, for example, one of the two controllers for the HDLC peripheral 25a can be dedicated to managing, on the basis of control instructions from the CPU 21, the time-slots containing O&M messages and which thus, as is known, have SAPIs (Service Access Point Indicators) whose value is other than zero. Likewise, one of the two controllers for the HDLC 25b peripheral can be dedicated to managing the time-slots containing RSL messages which, as is known, have SAPIs equal to 0.

Essentially, and in accordance with the present invention the HDLC peripheral 25a associated with the PCM driver 20 is capable of using control instructions from the CPU 21 to interpret the frames it receives so that those with SAPIs other than 0 (which thus d not transp rt RSL signals) can be retransmitted to the switch matrix 27 in such a way that they are included in the PCM stream between RBS 12 and BSC 11 without processing of any kind, with procedures equivalent to those used by the switch matrix 27 for time-slots that do not carry significant information.

In other words, the PCM driver 20 and, consequently, the instrument 14 are also “transparent” for the frames containing O&M messages, given that the TS used to transport them is initially switched on the internal PCM stream by switch matrix 27. Subsequently, once the HDIC peripheral 25a has determined the type of frame, these O&M messages are returned to transmission.

By contrast, the RSL messages whose SAPI is 0 are processed, e.g., by the HDLC peripheral 25b which, on the basis of the instructions stored in the RAM 22 and under the control of the CPU 21, is capable of sending the RSL messages to the RSL generator 40 via the fourth PCM stream (as described above, the other three streams are that with the BSC, that with the RBS, and the internal stream between the HDLC module 25 and the switch matrix 27), which is likewise connected to the switch matrix 27 and connected to the RSL generator 40 by means of the interconnection bus 60.

Naturally, as the connection involved is internal to the instrument 14 and is used exclusively to exchange information between the PCM driver 20 and the RSL generator 40, which, for example, consist of two electronic circuit boards, the format of the exchanged frames could be entirely arbitrary However, as software modules capable of implementing the LAPD layer 2 protocol are available for managing information between the RBS and BSC, the internal signaling used on the fourth PCM stream has also been made to comply with this specification. This also guarantees that information can be transferred with a high degree of reliability.

The RSL generator 40 comprises a CPU 41, consisting for example of an Intel model 80960JT-100 32-bit RISC microprocessor, a non-volatile memory (ROM) 43, c nsisting f r example f a 1 MB FLASH EPROM memory, and a volatile memory (RAM) 42, e.g. a 16 MB EDO DRAM random access mem ry, all of known type and mutually interconnected in accordance with the prior art by means of an internal data and command channel (BUS) 44.

The ROM 43 is capable of storing programs developed at the design stage for instrument 14, which for execution are transferred, e.g., by means of an appropriate boot program which is also resident in ROM 43, from the ROM 43 to the RAM 42 so that the CPU 41 can operate with extremely fast access times, as will be readily apparent to a person skilled in the art.

Finally, the RSL generator 40 comprises a peripheral (serial peripheral) 48, e.g., an RS232 asynchronous serial peripheral, for connection to the electronic computer 50 by means of connection 70, and an HDLC generator circuit (HDLC generator) 45, consisting for example of the Infineon PEB2075 component provided with four HDLC controllers designated as 45a, 45b, 45c and 45d respectively, connected by means of a PCM channel to the interconnection bus 60 and controlled in accordance with the prior art by CPU 41 via bus 44.

The serial peripheral 48 is capable of permitting data, instructions and programs to be transferred from the electronic computer 50 to the RSL generator 40 and, through the latter, to the PCM driver 20 and vice versa. For example, the serial peripheral 48 is capable of permitting programs stored in the computer 50 to be transferred to the RAM 42 associated with the RSL generator 40 and the RAM 22 associated with the PCM driver 20.

Each HDLC controller associated with the RSL generator 40, e.g., the HDLC controller 45a, is capable of managing the PCM traffic to be exchanged with an RBS 11 and the BSC 12, under the control of the CPU 41 and on the basis of programs of known type for managing and generating RSL messages stored in the RAM 42.

The electronic computer 50 consists, for example, of a personal computer or PC with Windows™ 95 operating system and comprising a 100 MHz Pentium microprocessor, 64 MByte RAM, a 1 Gbyte hard disc drive, a color monitor and at least one serial port

By means of programs developed at the design stage for instrument 14 and connection 70, the electronic computer (PC) 50 is capable of performing the following functions:

Managing communication with the RSL generator 40 and, by means of the latter, with the PCM driver or drivers 20;

Reading/writing configuration variables on the RSL generator 40 and on the PCM driver or drivers 20;

Reading statistical counters detected by the RSL generator 40 and by the PCM driver or drivers 20 by means of the programs stored in the respective RAM memories 42 and 22;

Reading the information stored in the RAM 42 and RAM 22 associated with the RSL generator 40 and with the PCM driver or drivers 20 respectively;

Causing traffic generation to start and stop.

Operation of the test plant test 10, which for the sake of simplicity has been described above with reference to a test plant having a single RBS and one BSC, is as follows.

Upon activation, the PCM driver 20 and the generator 40, in particular, are initialized by means of boot procedures stored in the respective ROMs 23 and 43 so that they are ready to receive commands and/or programs from the PC 50 via the connection 70.

Subsequently, the PC 50 can manage devices 20 and 40 by means of control programs which will appear, for example, as typical Windows™ 95 applications with a main window and several accessory windows to be activated as needed in order to view different categories of information and/or commands separately. Configuration data to be transmitted to devices 20 and 40 are entered by means of dialog boxes and/or through the use of initialization files (*.INI) of known type.

In the case where the PC 50 activates monitor mode functions for devices 20 and 40, f r example, the PCM frames from the BSC 11 and c ntaining the O&M and RSL messages are initially transferred by the switch matrix 27 to the HDLC module 25, which on the basis of an appropriate program stored in RAM 22 in order to perform the monitor function, transfers all the messages to the switch matrix 27 so that they can be transmitted transparently to both the RBS 12 and to the RSL generator 40.

In this type of operation, the RSL generator 40 is essentially inactive and, on the basis of an appropriate program stored in RAM 42 in order to perform the monitor function, transfers all received messages to the PC 50 so that they can be displayed on PC 50 in accordance with the prior art.

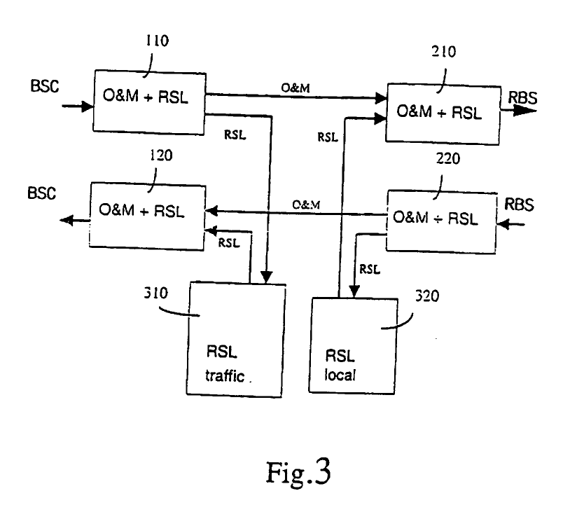

In the case where the PC 50 activates load generator functions for devices 20 and 40, the time-slots of the PCM frames from the BSC 11 and containing O&M and RSL messages (block 110; FIG. 3) are initially transferred by the switch matrix 27 (FIG. 2 and FIG. 3) to the HDLC module 25, which returns the O&M messages to the switch matrix 27 so that they are carried transparently to the RBS 12 (block 210).

The RSL messages, on the other hand, are transmitted to the switch matrix 27 so that they can be sent, via the PCM stream between the switch matrix 27 and the interconnection bus 60, to the RSL generator 40 (block 310) which generates RSL message traffic in accordance with the prior art and includes this traffic in the PCM stream between the switch matrix 27 and the BSC 11 (block 120).

In particular, the message generation device 40 is capable, by means of the application program stored in the RAM 42, of emulating a predetermined number of GSM mobile stations in accordance with the prior art and of occupying a predetermined number of radio resources; to this end, the application program for the RSL generator 40 is capable of managing, for example, the following databases:

MOBILE STATIONS: Database for the GSM mobile stations containing state variables concerning resource occupation and the GSM procedure in current use for a given emulated terminal;

RADIO CARRIERS: Database for radio carriers, where each carrier is described as a set of time-slots, and for the possible sub-channels, each described by a type and state variable;

MEASUREMENT REPORT: Database associated with active radio connections for which “measurement reports” can be generated on the A-bis interface.

The O&M and RSL messages from the RBS 12 (block 220) are transferred from the switch matrix 27 to the HDLC module 25 in the same way as described above. Here again, the O&M messages are returned to the switch matrix 27 so that they can be transferred transparently to the BSC 11 (block 120). By contrast, the RSL messages transmitted by the switch matrix 27 to the RSL generator 40 are managed locally by the RSL generator 40 (block 320) with no message load generation, and are sent to the RBS 12 (block 210).

The instrument 14, as described and in accordance with the present invention, is thus capable of generating RSL signaling traffic regardless of the proprietary O&M messages which travel transparently between the BSC 11 and RBS 12.

As described, the present invention makes it possible to implement test plants which are independent of the proprietary information which is currently required for this purpose.

In addition, the present invention makes it possible to implement instruments for testing digital mobile radio systems capable of connecting to an interface between a radio base station and the associated base station controller regardless of the manufacturer of said equipment. Thanks to the present invention, in fact, an agreement with equipment manufacturers whereby proprietary O&M messages can be managed is no longer necessary. Nor is it necessary to update the software release of the instrument contemplated by the present invention when the software release for the proprietary part of the interface is changed.

In describing the present invention, the PCM driver 20 and RSL generator 40 have been indicated as being implemented using separate electronic circuit boards. However, it will be readily apparent t a person skilled in the art that these devices can also be implemented using a single electronic circuit board or with a larger number of boards while continuing to provide the characteristics, features, capabilities and functions as described above.

Though the present invention has been described with reference to GSM networks and the A-bis interface, it will be readily apparent to a person skilled in the art that the same principles and the same approach can be used for equivalent mobile radio networks such as the UMS (Universal Mobile Telecommunications System) network on the I_{ub} interface.

The dimensions, forms, materials, components, circuit elements and contacts as contemplated in the foregoing description are capable of modifications in various obvious respects, as are the details of the circuitry and construction as illustrated and of the operating method, all without departing from the scope of the invention as specified in the appended claims.

1. A test plant for digital mobile radio systems (10), comprising
One or more radio base stations (12) capable of transmitting and receiving information comprising
Radio signaling link messages organized in accordance with a predetermined standard; and
Operation & Maintenance messages organized in accordance with proprietary specifications;
A base station controller (11) for said one or more radio base stations (12) capable of exchanging said information with said one or more radio base stations;
A test instrument (14) interposed between said one or more radio base stations (12) and said base station controller (11);
characterized in that
Said test instrument (14) is capable both of selectively filtering said radio signaling link messages and of making said Operation & Maintenance messages travel transparently between said base station controller (11) and said one or more radio base stations (12).

2. A test plant in accordance with claim 1, characterized in that
Said test instrument (14) is capable of generating new radio signaling link messages to be exchanged with said radio base stations (12) and/or said base station controller (11).

3. A test plant in accordance with claim 2, in which said test instrument comprises
At least one filter device (20) capable of filtering said information selectively; and
A message generation device (40) capable of generating said new radi signaling link messages.

4. A test plant in accordance with any of the foregoing claims, in which said information is organized in accordance with the GSM communication protocol.

5. An instrument (14) for testing digital mobile radio systems, comprising
First means of connection (26b) capable of being connected to one or more radio base stations (12) and capable of exchanging therewith information comprising
Radio signaling link messages organized in accordance with a predetermined standard; and
Operation & Maintenance messages organized in accordance with proprietary specifications; and
Second means of connection (26a) capable of being connected to a base station controller (11) for said one or more radio base stations (12) and capable of exchanging said information with said base station controller;
characterized by
Filtering means (25) connected to said first and second means of connection and capable both of selectively filtering said radio signaling link messages and of making said Operation & Maintenance messages travel transparently between said first and second means of connection (26b, 26a).

6. An instrument in accordance with claim 5, characterized in that said filtering means (20) comprise
Recognition means (25) capable of selectively recognizing said radio signaling link messages and said Operation & Maintenance messages; and
Switching means (27) connected t said recognition means (25) and to said first and second means of connection (26b, 26a) and capable of transferring said selectively recognized Operation & Maintenance messages from said first means of connection (26b) to said second means of connection (26a) and vice versa.

7. An instrument in accordance with claim 6, characterized in that said filtering means (20) comprise
Means of control (21) connected to said recognition means (25) and to said switching means (27) and capable of controlling said recognition means and said switching means on the basis of selectively definable parameters.

8. An instrument in accordance with any of claims 5 to 7, characterized in that said filtering means (20) consist of electronic circuit boards each capable of being connected to one of said radio base stations (12) and to said base station controller (11).

9. An instrument in accordance with any of claims 5 to 8, characterized by
Means for generating messages (40) connected to said filtration means (20) and capable of generating new radio signaling link messages to be exchanged with said first and/or second means of connection (26b, 26a).

10. An instrument in accordance with claim 9, characterized in that said filtration means (40) comprise
Message generation devices (41-43); and
Means of control (50) connected to said message generation devices (41-43) and capable of controlling the generation of said new radio signaling link messages on the basis of selectively definable parameters.

11. An instrument in accordance with claim 9 or 10, characterized in that said means for generating messages (40) consist of an electronic circuit board.
